(19) United States
(12) Patent Application Publication
(10) Pub. No.: US 2025/0004745 A1
(43) Pub. Date: Jan. 2, 2025

(54) MECHANISM FOR UPDATING FIRMWARE OF A THIRD PARTY DEVICE

(71) Applicant: GM Cruise Holdings LLC, San Francisco, CA (US)

(72) Inventors: Pierre Souillot, Berkeley, CA (US); Katherine Murphy, San Francisco, CA (US); Charles Z. Mooney, San Francisco, CA (US)

(73) Assignee: GM Cruise Holdings LLC, San Francisco, CA (US)

(21) Appl. No.: 18/342,009

(22) Filed: Jun. 27, 2023

(51) Int. Cl. G06F 8/65

(52) U.S. Cl. CPC G06F 8/65

(57) ABSTRACT

A system is described and includes a motherboard; a switch for connecting the motherboard to an autonomous vehicle (AV) ethernet network; a system manager connected to the motherboard for distributing power to the motherboard and the ethernet switch; and a safehold system connected to the system manager, wherein the safehold system is powered independently of the system manager; wherein the safehold system obtains from the motherboard a firmware image, provides the firmware image to the system manager, and monitors the system manager to determine whether updating of the firmware image on the system manager was successful.

### BACKGROUND

### Technical Field

The present disclosure relates generally to autonomous vehicles (AVs) and, more specifically, to techniques for updating firmware of a third party device in connection with such AVs.

### INTRODUCTION

An AV is a motorized vehicle that can navigate without a human driver. AVs include computers and control systems that perform driving and navigation tasks that are conventionally performed by a human driver. Such tasks require the collection and processing of large quantities of data using various sensors, including but not limited to, a camera sensor, a light detection and ranging (LIDAR) sensor, and a radio detection and ranging (RADAR) sensor, among others. The sensors collect data and measurements that the AV can use for operations such as navigation. The sensors can provide the data and measurements to an internal computing system of the AV, which can use the data and measurements to control a mechanical system of the AV, such as a vehicle propulsion system, a braking system, or a steering system. Typically, the sensors are mounted at fixed locations on the AVs.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example system environment that can be used to facilitate AV (AV) dispatch and operations, according to some aspects of the disclosed technology;

FIG. 2 illustrates a simplified block diagram of a system for implementing a third party device firmware update according to some aspects of the disclosed technology;

FIGS. 3A and 3B collectively illustrate a flow diagram of some example operations for implementing a third party device firmware update, according to some aspects of the disclosed technology;

FIG. 4 illustrates a flow diagram of additional example operations for implementing a third party device firmware update, according to some aspects of the disclosed technology;

FIG. 5 illustrates an example processor-based system with which some aspects of the disclosed technology can be implemented.

### DETAILED DESCRIPTION

### Overview

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

Given the numerous advantages of ride hail, rideshare, and delivery services (hereinafter collectively referred to as rideshare services provided by AVs, it is anticipated that AV provision of such services will soon become the ubiquitous choice for various user transportation and delivery needs, including but not limited to school commutes, airport transfers, long distance road trips, and grocery and restaurant deliveries, to name a few.

In some AV implementations, power delivery to various on-board components, such as the AV sensors and compute nodes, is controlled by a power distribution board (PDB). For example, a PDB can control power supply and distribution to various components residing on the AV. Some PDBs are designed to supply and distribute power to a device for data transmission, for example, a computer that can transmit data to the power distribution board.

A PDB can provide power to various components, including a device that is responsible for providing a firmware update and transmitting data to the PDB (e.g., a computer), all of which reside on an AV. However, due to a mutually dependent relationship between the PDB and the computer, a firmware update (e.g., flashing or overwriting of existing firmware) to the PDB can potentially cause the PDB to cease supplying power to the various components, including the computer as well as an ethernet switch. Moreover, corrupt firmware can either immediately cut power to a computer whose power is controlled by the PDB or be unable to boot a system once the power of the whole system is completely shut off. To remedy the foregoing limitations, the present disclosure utilizes different boot algorithms to update firmware on the PDB without interrupting any outputs and confirm that the firmware is proven. Specifically, the disclosed technology provides solutions for updating firmware on an upstream device (e.g., PDB) that controls power to a downstream device (e.g., computer) that transmits data relating to a firmware update. For example, the PDB can supply power to the computer and receive data regarding the firmware update from that computer.

Aspects of the disclosed technology address the foregoing limitations of some firmware update mechanism of PDBs, by providing systems, methods, and machine-readable media that provide solutions for improving a firmware update mechanism by utilizing different boot procedures. More specifically, a firmware update mechanism can be improved based on a mutually dependent relationship between the PDB and the computer.

In particular embodiments, a PDB includes a system manager comprising a microprocessor. System manager firmware may be updated over the air (OTA). A system manager firmware update is performed in response to an OTA request or command. In a particular architecture described hereinbelow, there are three possible paths for updating the system manager firmware. These three possible paths include an ethernet switch, a safehold system, and a computer (or motherboard). Updating the firmware via the ethernet switch may be a risk, as the PDB distributes power to the ethernet switch. Since the motherboard is also powered by the PDB, updating the system manager firmware using the motherboard suffers the same circular dependency issues as using the ethernet switch. In embodiments described herein, the safehold system comprises a microprocessor and is powered independently of the system manager, but depends on the ethernet switch to complete boot processes. If the system manager has a bug that fails to power on the ethernet switch, the safehold system will need to work around the dependency to recover the system manager independently.

In accordance with features of embodiments described herein, the safehold system may be the preferred path for updating the firmware of the system manager because it is independently powered. In particular embodiments, when the system manager completes the OTA update, the system manager will reboot the motherboard and the ethernet switches.

This reboot can be handled by the safehold system, which in particular implementations may include a processor that is a secondary processor to the motherboard and that may run Linux. In particular embodiments, safehold system may be responsible for various functions, including power moding as well as controlling cooling pumps for the vehicle and handling failover if a cooling pump stops working. With regard to power moding, the safehold system may determine an operational state of the vehicle and adjust a power consumption profile of the vehicle based on the determined operational state, thereby to implement power consumption objectives that may be identified for the vehicle. In accordance with features of embodiments described herein, the safehold system can further handle the revert to the previous system manager image if necessary and may be used as a backup recovery mechanism.

The following detailed description presents various descriptions of specific certain embodiments. However, the innovations described herein can be embodied in a multitude of different ways, for example, as defined and covered by the claims and/or select examples. In the following description, reference is made to the drawings, in which like reference numerals can indicate identical or functionally similar elements. It will be understood that elements illustrated in the drawings are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

The following disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting. It will of course be appreciated that in the development of any actual embodiment, numerous implementation-specific decisions must be made to achieve the developer's specific goals, including compliance with system, business, and/or legal constraints, which may vary from one implementation to another. Moreover, it will be appreciated that, while such a development effort might be complex and time-consuming; it would nevertheless be a routine undertaking for those of ordinary skill in the art having the benefit of this disclosure.

In the drawings, a particular number and arrangement of structures and components are presented for illustrative purposes and any desired number or arrangement of such structures and components may be present in various embodiments. Further, the structures shown in the figures may take any suitable form or shape according to material properties, fabrication processes, and operating conditions. For convenience, if a collection of drawings designated with different letters are present (e.g., FIGS. 10A-10C), such a collection may be referred to herein without the letters (e.g., as “FIG. 10”). Similarly, if a collection of reference numerals designated with different letters are present (e.g., 110a-110e), such a collection may be referred to herein without the letters (e.g., as “110”).

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, and/or conditions, the phrase “between X and Y” represents a range that includes X and Y. The terms “substantially,” “close,” “approximately,” “near,” and “about,” generally refer to being within +/−20% of a target value (e.g., within +/−5 or 10% of a target value) based on the context of a particular value as described herein or as known in the art.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Other features and advantages of the disclosure will be apparent from the following description and the claims.

### Example AV Management System

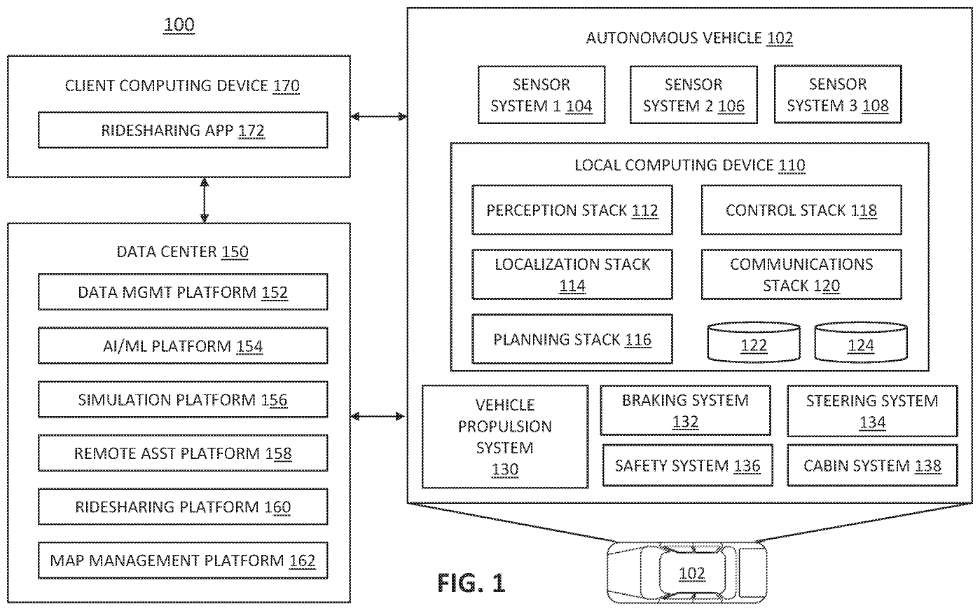

FIG. 1 illustrates an example of an AV management system 100. One of ordinary skill in the art will understand that, for the AV management system 100 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, another Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 102 can navigate roadways without a human driver based on sensor signals generated by multiple sensor systems 104, 106, and 108. The sensor systems 104-108 can include different types of sensors and can be arranged about the AV 102. For instance, the sensor systems 104-108 can comprise Inertial Measurement Units (IMUs), cameras (e.g., still image cameras, video cameras, etc.), light sensors (e.g., LIDAR systems, ambient light sensors, infrared sensors, etc.), RADAR systems, a Global Navigation Satellite System (GNSS) receiver, (e.g., Global Positioning System (GPS) receivers), audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other embodiments may include any other number and type of sensors.

AV 102 can also include several mechanical systems that can be used to maneuver or operate AV 102. For instance, the mechanical systems can include vehicle propulsion system 130, braking system 132, steering system 134, safety system 136, and cabin system 138, among other systems. Vehicle propulsion system 130 can include an electric motor, an internal combustion engine, or both. The braking system 132 can include an engine brake, a wheel braking system (e.g., a disc braking system that utilizes brake pads), hydraulics, actuators, and/or any other suitable componentry configured to assist in decelerating AV 102. The steering system 134 can include suitable componentry configured to control the direction of movement of the AV 102 during navigation. Safety system 136 can include lights and signal indicators, a parking brake, airbags, and so forth. The cabin system 138 can include cabin temperature control systems, in-cabin entertainment systems, and so forth. In some embodiments, the AV 102 may not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

AV 102 can additionally include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a planning stack 116, a control stack 118, a communications stack 120, a High Definition (HD) geospatial database 122, and an AV operational database 124, among other stacks and systems.

Perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 122, other components of the AV, and other data sources (e.g., the data center 150, the client computing device 170, third-party data sources, etc.). The perception stack 112 can detect and classify objects and determine their current and predicted locations, speeds, directions, and the like. In addition, the perception stack 112 can determine the free space around the AV 102 (e.g., to maintain a safe distance from other objects, change lanes, park the AV, etc.). The perception stack 112 can also identify environmental uncertainties, such as where to look for moving objects, flag areas that may be obscured or blocked from view, and so forth.

Mapping and localization stack 114 can determine the AV's position and orientation (pose) using different methods from multiple systems (e.g., GPS, IMUs, cameras, LIDAR, RADAR, ultrasonic sensors, the HD geospatial database 122, etc.). For example, in some embodiments, the AV 102 can compare sensor data captured in real-time by the sensor systems 104-108 to data in the HD geospatial database 122 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The planning stack 116 can determine how to maneuver or operate the AV 102 safely and efficiently in its environment. For example, the planning stack 116 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., an Emergency Vehicle (EMV) blaring a siren, intersections, occluded areas, street closures for construction or street repairs, DPVs, etc.), traffic rules and other safety standards or practices for the road, user input, and other relevant data for directing the AV 102 from one point to another. The planning stack 116 can determine multiple sets of one or more mechanical operations that the AV 102 can perform (e.g., go straight at a specified speed or rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 116 can select from multiple backup plans to carry out. For example, while preparing to change lanes to turn right at an intersection, another vehicle may aggressively cut into the destination lane, making the lane change unsafe. The planning stack 116 could have already determined an alternative plan for such an event, and upon its occurrence, help to direct the AV 102 to go around the block instead of blocking a current lane while waiting for an opening to change lanes.

The control stack 118 can manage the operation of the vehicle propulsion system 130, the braking system 132, the steering system 134, the safety system 136, and the cabin system 138. The control stack 118 can receive sensor signals from the sensor systems 104-108 as well as communicate with other stacks or components of the local computing device 110 or a remote system (e.g., the data center 150) to effectuate operation of the AV 102. For example, the control stack 118 can implement the final path or actions from the multiple paths or actions provided by the planning stack 116. This can involve turning the routes and decisions from the planning stack 116 into commands for the actuators that control the AV's steering, throttle, brake, and drive unit.

The communication stack 120 can transmit and receive signals between the various stacks and other components of the AV 102 and between the AV 102, the data center 150, the client computing device 170, and other remote systems. The communication stack 120 can enable the local computing device 110 to exchange information remotely over a network, such as through an antenna array or interface that can provide a metropolitan WIFI® network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communication stack 120 can also facilitate local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth©, infrared, etc.).

The HD geospatial database 122 can store HD maps and related data of the streets upon which the AV 102 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane or road centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines, and/or boundaries, etc.) and related attributes (e.g., permissive, protected/permissive, or protected only left turn lanes; permissive, protected/permissive, or protected only U-turn lanes; permissive or protected only right turn lanes; etc.). The traffic controls layer can include geospatial information of traffic signal lights, traffic signs, and other road objects and related attributes.

The AV operational database 124 can store raw AV data generated by the sensor systems 104-108 and other components of the AV 102 and/or data received by the AV 102 from remote systems (e.g., the data center 150, the client computing device 170, etc.). In some embodiments, the raw AV data can include HD LIDAR point cloud data, image or video data, RADAR data, GPS data, and other sensor data that the data center 150 can use for creating or updating AV geospatial data.

The data center 150 can be a private cloud (e.g., an enterprise network, a co-location provider network, etc.), a public cloud (e.g., an IaaS network, a PaaS network, a SaaS network, or other CSP network), a hybrid cloud, a multi-cloud, and so forth. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes one or more of a data management platform 152, an Artificial Intelligence/Machine Learning (AI/ML) platform 154, a simulation platform 156, a remote assistance platform 158, a ridesharing platform 160, and a map management platform 162, among other systems.

Data management platform 152 can be a “big data” system capable of receiving and transmitting data at high speeds (e.g., near real-time or real-time), processing a large variety of data, and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service data, map data, audio data, video data, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridesharing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridesharing platform 160, the map management platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from the map management platform 162; modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridesharing platform 160 can interact with a customer of a ridesharing service via a ridesharing application 172 executing on the client computing device 170. The client computing device 170 can be any type of computing system, including a server, desktop computer, laptop, tablet, smartphone, smart wearable device (e.g., smart watch; smart eyeglasses or other Head-Mounted Display (HMD); smart ear pods or other smart in-ear, on-ear, or over-ear device; etc.), gaming system, or other general purpose computing device for accessing the ridesharing application 172. The client computing device 170 can be a customer's mobile computing device or a computing device integrated with the AV 102 (e.g., the local computing device 110). The ridesharing platform 160 can receive requests to be picked up or dropped off from the ridesharing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as tracking specific changes that (human or machine) map editors have made to the data and reverting changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some embodiments, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ridesharing platform 160 may incorporate the map viewing services into the client application 172 to enable passengers to view the AV 102 in transit en route to a pick-up or drop-off location, and so on.

### Example System for Performing Third Party Device Firmware Update

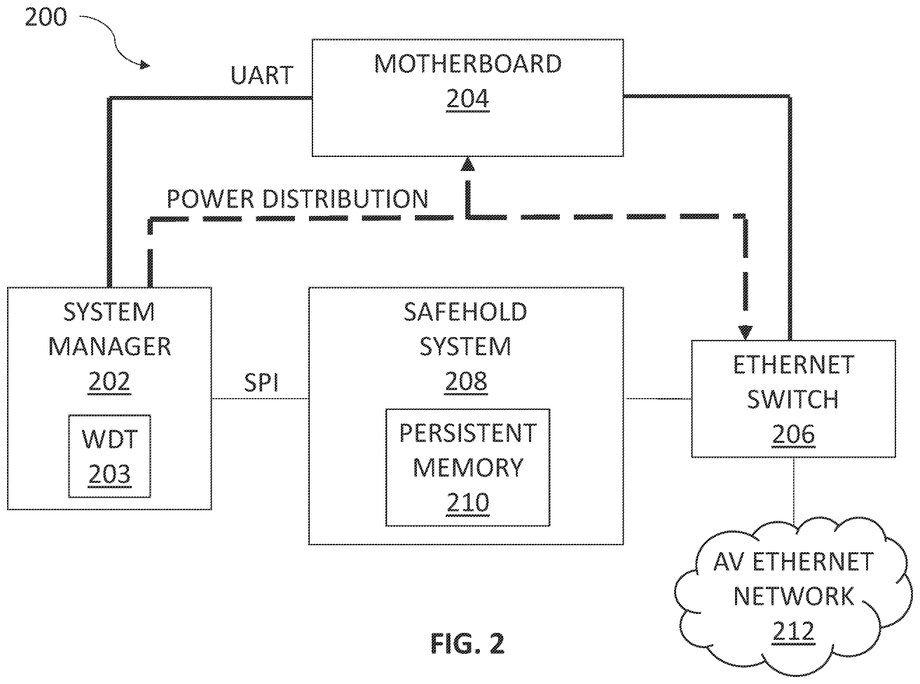

FIG. 2 illustrates a simplified block diagram of a system 200 for implementing a third party device firmware update. As shown in FIG. 2, system 200 includes a system manager 202, which in particular embodiments comprises a PDB and which includes a watchdog timer (WDT) 203 for purposes that will be described in greater detail below. In the illustrated embodiment, system manager 202 distributes power to a motherboard 204 and an ethernet switch 206. As such, operation of motherboard 204 and ethernet switch 206 is dependent on proper operation of system manager 202. In accordance with features of embodiments described herein, system 200 further includes a safehold system 208, which in particular embodiments comprises a Linux system, for example, and includes persistent memory 210 for purposes to be described in greater detail below. Notably, safehold system 208 is powered independently from system manager 202 and therefore is not dependent on system manager 202 for proper operation. In certain embodiments, safehold system 208 may perform power moding functions for an AV and may further implement a backup AV planning stack comprising a minimal version of the planning stack for use in situations in which a primary planning stack fails.

As illustrated in FIG. 2, safehold system 208 communicates with system manager 202 via a serial peripheral interface (SPI) connection. Motherboard 204 communicates with system manager 202 via a universal asynchronous receiver/transmitter (UART) connection.

As previously noted, motherboard 204 and ethernet switch 206 are dependent on system manager 202 for power, such that if a firmware update of the system manager fails for some reason, neither the motherboard nor the ethernet switch will be available to aid in the recovery of the system manager.

In accordance with features of embodiments described herein, in order to overcome the aforementioned issues, safehold system 208, which as previously noted is not dependent on system manager 202 for power, monitors the firmware update of the system manager as described in greater detail below. In particular, due to implementation of a wakeup flow architecture on system manager 202, when the system manager completes the OTA (i.e., the firmware update), it will reboot motherboard 204 and ethernet switch 206. This reboot can be handled by safehold system 208, which, as described above, may be otherwise responsible for power moding in the system 200 and is therefore robust enough to do so. Safehold system 208 can also handle reversion of the system manager 202 to the previous (i.e., backup) firmware image, should that be necessary, and can also be used as a backup recovery mechanism.

In accordance with features of particular embodiments, safehold system 208 receives an updated firmware image for system manager 202, as well as a backup firmware image (e.g., the last known verified image), from motherboard 204, which downloads the image from an AV ethernet network 212 via ethernet switch 206. Safehold system 208 stores the firmware images in persistent memory 210. During OTA, safehold system 208 sends the updated firmware image to system manager 202 over the SPI link. A communication integrity check is performed by system manager 202 upon receipt of the updated firmware image. Once the firmware upgrade is complete, safehold system 208 confirms that system manager 202 can communicate with the motherboard 204 and ethernet switch 206 before marking the image verified. Upon expiration of the WDT 203 without confirmation of communication between the system manager 202 and the motherboard 204 and ethernet switch 206, the safehold system 208 sends the backup image stored in persistent memory 210 to the system manager 202. In this situation, it may be necessary to power down motherboard 204 and ethernet switch 206 to avoid thermal issues.

### Example Methods for Third Party Device Firmware Update

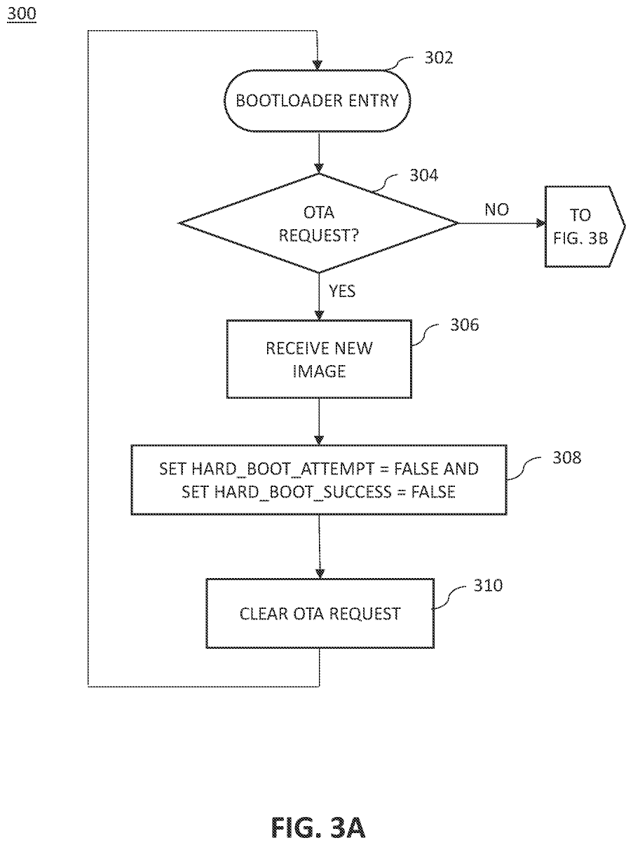

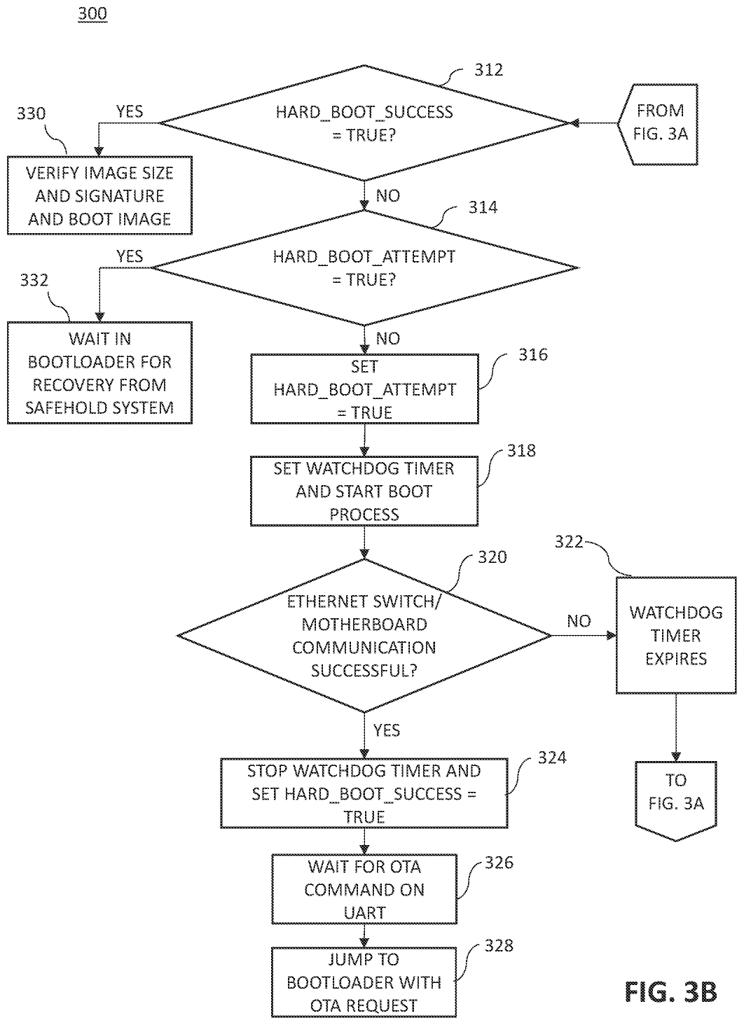

FIGS. 3A and 3B collectively illustrate a flow diagram 300 of certain example operations for third party device firmware update, according to some aspects of the disclosed technology. In certain embodiments, one or more of the operations illustrated in FIGS. 3A and 3B may be executed by one or more of the elements shown in FIGS. 1 and/or 2. In particular, FIGS. 3A and 3B illustrates example operations performed during a bootloader sequence of system manager 202.

Execution starts in 302 upon bootloader entry.

In 304, a determination is made whether an OTA request (or command) has been received (e.g., on the UART interface) to update the firmware image. If an OTA request has not been received, execution proceeds to 306.

In 306, the new firmware image is received from the motherboard (e.g., motherboard 204), which downloads the image from the AV ethernet network (e.g., AV ethernet network).

In 308, a flag designated hard_boot_attempt is set to FALSE. Additionally, a flag designated hard_boot_success is set to FALSE.

In 310, the OTA request is cleared. Upon completion of 310, execution returns to 302.

If in 302 it is determined that an OTA request has not been received, execution proceeds to 312.

In 312, a determination is made whether a flag designated hard_boot_success is set to TRUE. If it is determined in 312 that hard_boot_success is not set to TRUE, execution proceeds to 314.

In 314, a determination is made whether a flag designated hard_boot_attempt is set to TRUE. If it is determined in 314 that hard_boot_attempt is not set to TRUE, indicating that no previous attempt at a hard boot of the system manager has been made, execution proceeds to 316.

In 316, hard_boot_attempt is set to TRUE, indicating that that a hard boot is currently being attempted.

In 318, a watchdog timer (e.g., WDT 203 (FIG. 2)) is set to a predetermined amount of time (e.g., ten minutes) and the boot process is initiated. In particular embodiments, this command is on the SPI interface from the safehold system.

In 320, a determination is made whether communication by the system manager with motherboard (e.g., motherboard 204 (FIG. 2)) and ethernet switch (e.g., ethernet switch 206 (FIG. 2)) has been successful. In other words, a determination is made whether motherboard and ethernet switch are powered on (indicating that the system manager, which distributes power to those elements, is operable). If it is determined in 320 that communication by the system manager with the motherboard and the ethernet switch has not been successful, execution proceeds to 322.

In 322, after the watchdog timer set in 318 expires, indicating a preselected period of time (i.e., 10 minutes) has expired without successful communication between the system manager and the motherboard/ethernet switch, execution returns to 302. Once again, this is typically executed as an SPI from the safehold system.

If it is determined in 320 that communication by the system manager with the motherboard/ethernet has been successful, execution proceeds to 324.

In 324, the WDT is stopped and a verified_image flag and a hard_boot_attempt flag are set to TRUE.

In 326, system manager awaits an OTA request (or command) on the UART interface. Once an OTA command is received, execution proceeds to 328.

In 328, a jump to bootloader sequence with OTA request is performed. A result of 328 is that execution returns to 302 and the proceeds to 304, 306, and so on.

Returning again to 312, if in 312, hard_boot_success is determined to be set to TRUE, execution proceeds to 330.

In 330, the image size and signature of the received firmware image are verified and the image is booted.

Returning again to 314, if in 314, hard_boot_attempt is determined to be set to TRUE, indicating that a hard boot has been attempted and failed, execution proceeds to 332.

In 332, system manager waits in the bootloader for recovery by safehold system (e.g., safehold system 208 (FIG. 2)).

Although the operations of the example method shown in and described with reference to FIGS. 3A and 3B are illustrated as occurring once each and in a particular order, it will be recognized that the operations may be performed in any suitable order and repeated as desired. Additionally, one or more operations may be performed in parallel. Furthermore, the operations illustrated in FIGS. 3A and 3B may be combined or may include more or fewer details than described.

In particular embodiments, the hard_boot_attempt flag indicates whether a first hard boot (or full reboot) has been attempted with new firmware. When the update is first applied, the hard_boot_attempt flag is set to FALSE (e.g., in 308) because no attempt to boot with the new firmware has yet been made; system manager has reset itself and is ready to attempt to boot into the updated firmware for the first time. The hard_boot_attempt flag is set to TRUE when an attempt to boot from the updated firmware is first made (e.g., in 318). The bootloader reads the value of the hard_boot_attempt flag on subsequent boots to infer whether or not the first boot after a firmware update was successful.

Similarly, when the update is first applied, the hard_boot_success flag is set to FALSE (e.g., in 308) because no attempt to boot with the new firmware has yet been made and therefore a successful boot has not been achieved. The hard_boot_success flag is set to TRUE only after booting with the updated firmware has been successful and some basic functionality has been demonstrated by confirming that communications with the motherboard are operational (e.g., in 324).

In general, when the system manager resets, the bootloader looks to the values of these flags to determine how to proceed. If the hard_boot_attempt flag is set to FALSE, the bootloader is booting from a fresh, untested firmware image. If the hard_boot_attempt flag is set to TRUE and the hard_boot_success flag is set to FALSE, a boot from the firmware image has already been attempted and communications have failed, so the image is likely faulty. If the hard_boot_success flag is set to TRUE, the firmware image has been tested at least once and booting from the image has succeeded, so the firmware image is likely a good one.

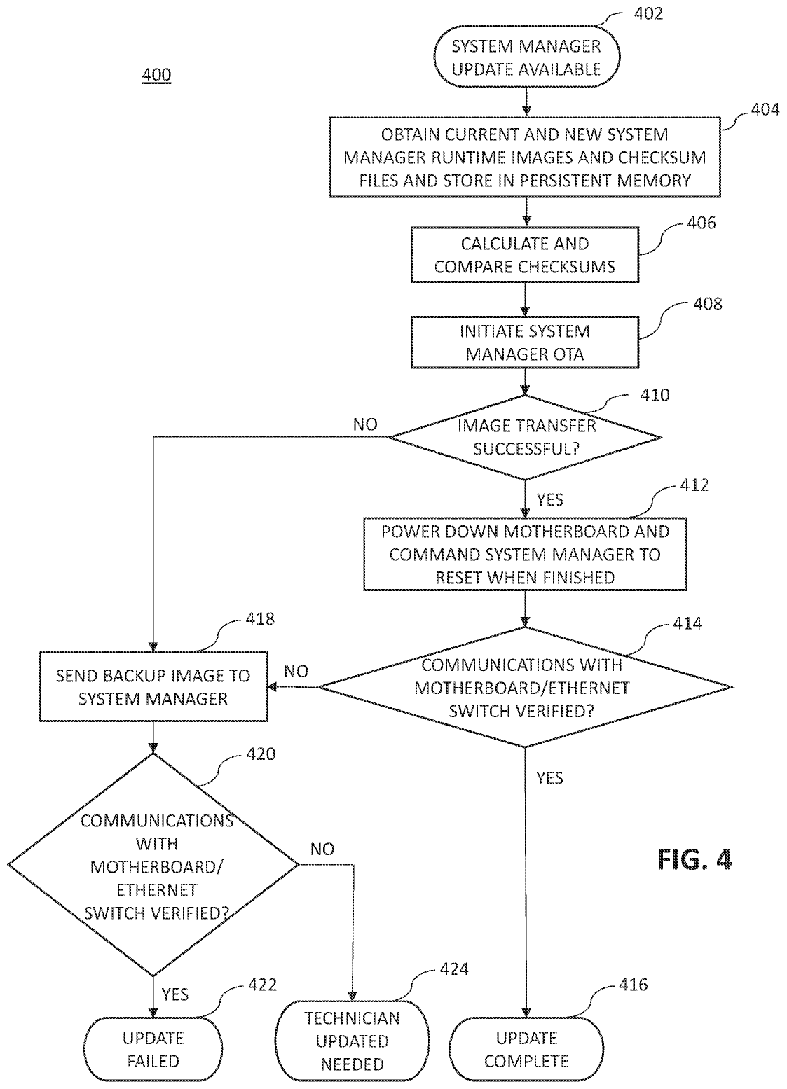

FIG. 4 illustrates a flow diagram 400 of example operations for third party device firmware update, according to some aspects of the disclosed technology. In certain embodiments, one or more of the operations illustrated in FIG. 4 may be executed by one or more of the elements shown in FIGS. 1 and/or 2. In particular, FIG. 4 illustrates example operations of a control flow performed by safehold system 208 (FIG. 2) during OTA of system manager 202 (FIG. 2).

Execution begins in 402 when a system manager firmware update is available from motherboard (e.g., motherboard 204 (FIG. 2).

In 404, a backup and new system manager runtime (e.g., firmware) images and checksum files are obtained from motherboard by safehold system and stored in persistent memory (e.g., persistent memory 210 (FIG. 2)).

In 406, checksums are calculated and compared for verification purposes.

In 408, system manager OTA is initiated by safehold system. Operations performed in 408 may include one or more of operations illustrated in flow diagram 300 (FIGS. 3A and 3B).

In 410, a determination is made whether image transfer from safehold system to system manager has been successful. If it is determined at 410 that image transfer has been successful, execution proceeds to 412.

In 412, the motherboard is powered down and the safehold system commands the system manager to reset when finished updating.

In 414, a determination is made whether communications with the motherboard and the ethernet switch have been verified. If it is determined in 414 that such communications have been verified, execution proceeds to 416.

In 416, the firmware update of the system manager is deemed to have completed successfully.

If in 410 it is determined that the image transfer was not successful, execution proceeds to 418. The image transfer may be determined to have been unsuccessful for a variety of reasons, including but not limited to, a communications error or interruption (caused by, e.g., a power glitch or checksum failure), a corrupt image, an invalid image signature, or an invalid image size, for example.

Similarly, if in 414 it is determined that communications with the motherboard and ethernet switch have not been verified, execution proceeds to 418.

In 418, the backup image is sent from the safehold system to the system manager. Operations performed in 418 may include one or more of operations illustrated in flow diagram 300 (FIGS. 3A and 3B).

In 420, a determination is made whether communications with the motherboard and the ethernet switch have been verified. If it is determined in 420 that such communications have been verified, execution proceeds to 422.

In 422, the update is deemed to have failed, as reversion to the backup image has occurred.

If in 420 it is determined that communications with the motherboard and the ethernet switch cannot be verified, execution proceeds to 424.

In 424, firmware update of the system manager by a technician is deemed necessary, as reversion to the backup image has failed.

In particular embodiments, 402-406 involve interactions between motherboard and safehold processor, while 408-420 involve interactions between safehold processor and system manager.

Although the operations of the example method shown in and described with reference to FIG. 4 are illustrated as occurring once each and in a particular order, it will be recognized that the operations may be performed in any suitable order and repeated as desired. Additionally, one or more operations may be performed in parallel. Furthermore, the operations illustrated in FIG. 4 may be combined or may include more or fewer details than described.

### Example Processor-Based System

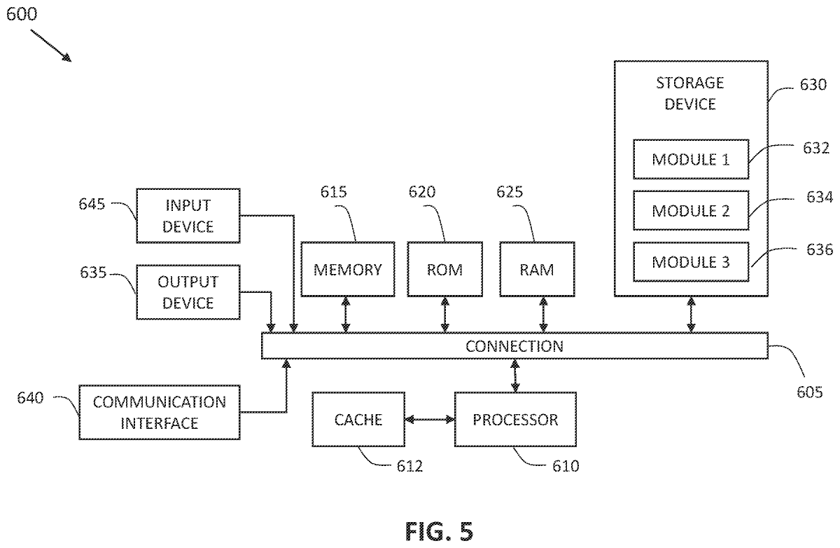

FIG. 5 illustrates an example processor-based system with which some aspects of the subject technology can be implemented. For example, processor-based system 600 can be any computing device making up, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 600 includes at least one processing unit (Central Processing Unit (CPU) or processor) 610 and connection 605 that couples various system components including system memory 615, such as Read-Only Memory (ROM) 620 and Random-Access Memory (RAM) 625 to processor 610. Computing system 600 can include a cache of high-speed memory 612 connected directly with, in close proximity to, or integrated as part of processor 610.

Processor 610 can include any general purpose processor and a hardware service or software service, such as services 632, 634, and 636 stored in storage device 630, configured to control processor 610 as well as a special purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a USB port/plug, an Apple® Lightning® port/plug, an Ethernet port/plug, a fiber optic port/plug, a proprietary wired port/plug, a Bluetooth® wireless signal transfer, a Bluetooth® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, WLAN signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 640 may also include one or more GNSS receivers or transceivers that are used to determine a location of the computing system 600 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory and/or computer-readable memory device and can be a hard disk or other types of computer-readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid state memory, a Compact Disc Read-Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Static RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L#), Resistive RAM (RRAM/ReRAM), Phase Change Memory (PCM), Spin Transfer Torque RAM (STT-RAM), another memory chip or cartridge, and/or a combination thereof.

Storage device 630 can include software services, servers, services, etc., that when the code that defines such software is executed by the processor 610, it causes the system 600 to perform a function. In some embodiments, a hardware service that performs a particular function can include the software component stored in a computer-readable medium in connection with the necessary hardware components, such as processor 610, connection 605, output device 635, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network personal computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### Selected Examples

Example 1 provides a system including a motherboard; an ethernet switch for connecting the motherboard to an autonomous vehicle (AV) ethernet network; a system manager connected to the motherboard for distributing power to the motherboard and the ethernet switch; and a safehold system connected to the system manager, wherein the safehold system is powered independently of the system manager; wherein the safehold system obtains from the motherboard a firmware image, provides the firmware image to the system manager, and monitors the system manager to determine whether updating of the firmware image on the system manager was successful.

Example 2 provides the system of example 1, wherein the safehold system includes persistent memory and wherein the firmware image obtained from the motherboard is stored in the persistent memory.

Example 3 provides the system of example 2, wherein a backup firmware image is stored in the persistent memory.

Example 4 provides the system of example 3, wherein the backup firmware image comprises a last known verified firmware image for the system manager.

Example 5 provides the system of example 3, wherein if it is determined that updating of the firmware image on the system manager was not successful, the safehold system provides the backup firmware image to the system manager.

Example 6 provides the system of example 1, wherein subsequent to the providing the firmware image to the system manager, the safehold system determines whether the system manager has successfully communicated with the motherboard and the ethernet switch.

Example 7 provides the system of example 1, wherein the safehold system comprises a Linux system.

Example 8 provides the system of example 1, wherein the system manager comprises a power distribution system.

Example 9 provides the system of example 1, wherein the safehold system is connected to the system manager via a serial peripheral interface (SPI) link.

Example 10 provides the system of example 1, wherein the system manager is connected to the motherboard via a universal asynchronous receiver/transmitter (UART) link.

Example 11 provides a method including determining by a first microprocessor device that a firmware update for a second microprocessor device is available, wherein the second microprocessor device distributes power to a motherboard and an ethernet switch and the first microprocessor device is powered independently of the second microprocessor device; downloading an image comprising the firmware update to a persistent memory of the first microprocessor device; transferring the image by the first microprocessor device to the second microprocessor device; determining that the image was successfully installed on the second microprocessor device; and subsequent to the determining, confirming that the second microprocessor device is in communication with the motherboard and an ethernet switch.

Example 12 provides the method of example 11, wherein the image is downloaded from an autonomous vehicle (AV) ethernet network via the ethernet switch and the motherboard.

Example 13 provides the method of example 11, further comprising determining whether a watchdog timer of the second microprocessor device has expired prior to communications between the second microprocessor device and the motherboard and the ethernet switch being successful.

Example 14 provides the method of example 11, wherein the image comprises a first image, the method further comprising storing a backup image comprising a previous firmware update for the second microprocessor device in the persistent memory.

Example 15 provides the method of example 14, further comprising transferring the backup image by the first microprocessor device to the second microprocessor device if it is determined that the first image was not successfully installed on the second microprocessor device.

Example 16 provides the method of example 15, further comprising determining whether the backup image was successfully installed on the second microprocessor device; and, subsequent to a determination that the backup image was successfully installed on the second microprocessor device, confirming that the second microprocessor device is in communication with the motherboard and an ethernet switch.

Example 17 provides the method of example 14, wherein the backup image comprises a last known verified firmware image for the second microprocessor device.

Example 18 provides a method comprising initiating a bootloader process in connection with a first microprocessor device; receiving a firmware image from a second microprocessor device, wherein the first microprocessor device distributes power to a motherboard and an ethernet switch and the second microprocessor device is powered independently of the first microprocessor device; setting a watchdog timer on the first microprocessor device; attempting to boot the first microprocessor device using the firmware image; and, subsequent to the attempting, determining whether the first microprocessor device is able to communicate with the motherboard and the ethernet switch and, upon a determination that the first microprocessor device is able to communicate with the motherboard and the ethernet switch, stopping the watchdog timer.

Example 19 provides the method of example 18, further comprising, upon expiration of the watchdog timer prior to the first microprocessor device being able to communicate with the motherboard and the ethernet switch, awaiting initiation of a recovery process by the second microprocessor device.

Example 20 provides the method of example 19, wherein the recovery process comprises the second microprocessor device providing to the first microprocessor device a backup firmware image, wherein the backup firmware image comprises a last known verified firmware image for the first microprocessor device.

### OTHER IMPLEMENTATION NOTES, VARIATIONS, AND APPLICATIONS

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

In one example embodiment, any number of electrical circuits of the figures may be implemented on a board of an associated electronic device. The board can be a general circuit board that can hold various components of the interior electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), computer-readable non-transitory memory elements, etc. can be suitably coupled to the board based on particular configuration needs, processing demands, computer designs, etc. Other components such as exterior storage, additional sensors, controllers for audio/video display, and peripheral devices may be attached to the board as plug-in cards, via cables, or integrated into the board itself. In various embodiments, the functionalities described herein may be implemented in emulation form as software or firmware running within one or more configurable (e.g., programmable) elements arranged in a structure that supports these functions. The software or firmware providing the emulation may be provided on non-transitory computer-readable storage medium comprising instructions to allow a processor to carry out those functionalities.

It is also imperative to note that all of the specifications, dimensions, and relationships outlined herein (e.g., the number of processors, logic operations, etc.) have only been offered for purposes of example and teaching only. Such information may be varied considerably without departing from the spirit of the present disclosure, or the scope of the appended examples. The specifications apply only to one non-limiting example and, accordingly, they should be construed as such. In the foregoing description, example embodiments have been described with reference to particular arrangements of components. Various modifications and changes may be made to such embodiments without departing from the scope of the appended examples. The description and drawings are, accordingly, to be regarded in an illustrative rather than in a restrictive sense.

Note that with the numerous examples provided herein, interaction may be described in terms of two, three, four, or more components; however, this has been done for purposes of clarity and example only. It should be appreciated that the system can be consolidated in any suitable manner. Along similar design alternatives, any of the illustrated components, modules, and elements of the FIGS. may be combined in various possible configurations, all of which are clearly within the broad scope of this Specification.

Various operations may be described as multiple discrete actions or operations in turn in a manner that is most helpful in understanding the example subject matter. However, the order of description should not be construed as to imply that these operations are necessarily order dependent. In particular, these operations may not be performed in the order of presentation. Operations described may be performed in a different order from the described embodiment. Various additional operations may be performed, and/or described operations may be omitted in additional embodiments.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

Numerous other changes, substitutions, variations, alterations, and modifications may be ascertained to one skilled in the art and it is intended that the present disclosure encompass all such changes, substitutions, variations, alterations, and modifications as falling within the scope of the appended examples. Note that all optional features of the systems and methods described above may also be implemented with respect to the methods or systems described herein and specifics in the examples may be used anywhere in one or more embodiments.

In order to assist the United States Patent and Trademark Office (USPTO) and, additionally, any readers of any patent issued on this application in interpreting the examples appended hereto, Applicant wishes to note that the Applicant: (a) does not intend any of the appended examples to invoke paragraph (f) of 35 U.S.C. Section 112 as it exists on the date of the filing hereof unless the words “means for” or “step for” are specifically used in the particular examples; and (b) does not intend, by any statement in the Specification, to limit this disclosure in any way that is not otherwise reflected in the appended examples.

What is claimed is:

1. A system comprising:
a motherboard;
a network switch for connecting the motherboard to an autonomous vehicle (AV) ethernet network;
a system manager connected to the motherboard for distributing power to the motherboard and the ethernet switch; and
a safehold system connected to the system manager, wherein the safehold system is powered independently of the system manager;
wherein the safehold system obtains from the motherboard a firmware image, provides the firmware image to the system manager, and monitors the system manager to determine whether updating of the firmware image on the system manager was successful.

2. The system of claim 1, wherein the safehold system includes persistent memory and wherein the firmware image obtained from the motherboard is stored in the persistent memory.

3. The system of claim 2, wherein a backup firmware image is stored in the persistent memory.

4. The system of claim 3, wherein the backup firmware image comprises a last known verified firmware image for the system manager.

5. The system of claim 3, wherein if it is determined that updating of the firmware image on the system manager was not successful, the safehold system provides the backup firmware image to the system manager.

6. The system of claim 1, wherein subsequent to the providing the firmware image to the system manager, the safehold system determines whether the system manager has successfully communicated with the motherboard and the ethernet switch.

7. The system of claim 1, wherein the safehold system comprises a Linux system.

8. The system of claim 1, wherein the system manager comprises a power distribution system.

9. The system of claim 1, wherein the safehold system is connected to the system manager via a serial peripheral interface (SPI) link.

10. The system of claim 1, wherein the system manager is connected to the motherboard via a universal asynchronous receiver/transmitter (UART) link.

11. A method comprising:
determining by a first microprocessor device that a firmware update for a second microprocessor device is available, wherein the second microprocessor device distributes power to a motherboard and an ethernet switch and the first microprocessor device is powered independently of the second microprocessor device;
downloading an image comprising the firmware update to a persistent memory of the first microprocessor device;
transferring the image by the first microprocessor device to the second microprocessor device;
determining that the image was successfully installed on the second microprocessor device; and
subsequent to the determining, confirming that the second microprocessor device is in communication with the motherboard and an ethernet switch.

12. The method of claim 11, wherein the image is downloaded from an autonomous vehicle (AV) ethernet network via the ethernet switch and the motherboard.

13. The method of claim 11, further comprising determining whether a watchdog timer of the second microprocessor device has expired prior to communications between the second microprocessor device and the motherboard and the ethernet switch being successful.

14. The method of claim 11, wherein the image comprises a first image, the method further comprising storing a backup image comprising a previous firmware update for the second microprocessor device in the persistent memory.

15. The method of claim 14, further comprising transferring the backup image by the first microprocessor device to the second microprocessor device if it is determined that the first image was not successfully installed on the second microprocessor device.

16. The method of claim 15, further comprising:
determining whether the backup image was successfully installed on the second microprocessor device; and
subsequent to a determination that the backup image was successfully installed on the second microprocessor device, confirming that the second microprocessor device is in communication with the motherboard and an ethernet switch.

17. The method of claim 14, wherein the backup image comprises a last known verified firmware image for the second microprocessor device.

18. A method comprising:
initiating a bootloader process in connection with a first microprocessor device;
receiving a firmware image from a second microprocessor device, wherein the first microprocessor device distributes power to a motherboard and an ethernet switch and the second microprocessor device is powered independently of the first microprocessor device;
setting a watchdog timer on the first microprocessor device;
attempting to boot the first microprocessor device using the firmware image; and
subsequent to the attempting, determining whether the first microprocessor device is able to communicate with the motherboard and the ethernet switch and, upon a determination that the first microprocessor device is able to communicate with the motherboard and the ethernet switch, stopping the watchdog timer.

19. The method of claim 18, further comprising, upon expiration of the watchdog timer prior to the first microprocessor device being able to communicate with the motherboard and the ethernet switch, awaiting initiation of a recovery process by the second microprocessor device.

20. The method of claim 19, wherein the recovery process comprises the second microprocessor device providing to the first microprocessor device a backup firmware image, wherein the backup firmware image comprises a last known verified firmware image for the first microprocessor device.
